(19) United States
(12) Patent Application Publication
(10) Pub. No.: US 2016/0301599 A1
(43) Pub. Date: Oct. 13, 2016

(54) METHOD AND FIRST NETWORK NODE FOR MANAGING A FIRST IP PATH USED BY A CONNECTION

(71) Applicant: TELEFONAKTIEBOLAGET L M ERICSSON (PUBL), Stockholm (SE)

(72) Inventors: Claudio PORFIRI, Stockholm (SE); Pål DAMMVIK, Solna (SE)

(21) Appl. No.: 15/037,228

(22) PCT Filed: Nov. 19, 2013
(86) PCT No.: PCT/SE2013/051355

§ 371 Date: May 17, 2016

(51) Int. Cl. H04L 12/707; H04L 12/24; H04L 12/841; H04L 12/26

(52) U.S. Cl. CPC H04L 45/22; H04L 43/0864; H04L 43/16; H04L 41/0668; H04L 47/283

(57) ABSTRACT

A first network node and a method therein for managing a first Internet Protocol (IP) path used by a connection between the first network node and a second network node are disclosed. The connection is established in a transport layer of the first and second network nodes. The first network node determines an indication of delay for a packet travelling in the first IP path. The first network node estimates a second derivative of the indication of delay. The second derivative of the indication of delay indicates a rate of change of the indication of delay. The first network node sets, based on the second derivative of the indication of delay, a counter for tracking the rate of change of the indication of delay. The first network node modifies the connection to use a second IP path for transmission of packets between the first network node and the second network node, when the counter exceeds a threshold value.

### TECHNICAL FIELD

Embodiments herein relate to communication networks, such as transport protocol networks. A first network node and a method therein for managing a first Internet Protocol path used by a connection between the first network node and a second network node are disclosed. Furthermore, a computer program and a computer program product are disclosed.

### BACKGROUND

In computer networks, a protocol known as Stream Control Transport Protocol (SCTP) provides resilience towards network failures by having the capability to select between several Internet Protocol (IP) paths for an association, e.g. a communication link or the like, between two nodes. The association is used by SCTP for transmission of information between the two nodes. A function for selection between several IP paths is often referred to as multi-homing. The IP paths can be routed different routes through a network. Thus, if one path is congested, SCTP may switch to another path in order to enable continued traffic on the association handled by SCTP.

In Request For Comments (RFC) 4960, section 3.3.5, provided by Internet Engineering Task Force (IETF), a procedure for detecting a problem on an IP path between a sender and a receiver is based on so called heartbeat messages, which includes time information relating to a transmission of the heartbeat message. The sender sends heartbeat messages to the receiver in order to detect problems on the IP path. Once a number of heartbeat messages are lost, i.e. not returned to the sender, the IP path is declared as failed by the sender and another IP path is selected by the sender. Heartbeat messages may be considered to be lost if a waiting time from sending of the heartbeat message, as given by the time information relating to the transmission of the heartbeat message, to reception of the heartbeat message is long enough. Sometimes, the waiting time is referred to as delay.

A problem with the known procedure may be that there may be an interruption in the traffic due to failed transmission on the IP path that is declared as failed.

### SUMMARY

An object is to improve management of IP paths in a network, e.g. using a multi-homed protocol, such as the above mentioned SCTP.

According to an aspect, the object is achieved by a method, performed by a first network node, for managing a first IP path used by a connection between the first network node and a second network node. The connection is established in a transport layer of the first and second network nodes. The transport layer is supported by an IP layer of the first and second network nodes. The first network node manages a second IP path for use by the connection. The first network node determines an indication of delay for a packet travelling in the first IP path. The indication relates to time for the packet to travel between the first network node and the second network node. The first network node estimates a second derivative of the indication of delay. The second derivative of the indication of delay indicates a rate of change of the indication of delay. The first network node sets, based on the second derivative of the indication of delay, a counter for tracking the rate of change of the indication of delay. Furthermore, the first network node modifies the connection to use the second IP path for transmission of packets between the first network node and the second network node, when the counter exceeds a threshold value.

According to another aspect, the object is achieved by a first network node configured to manage a first IP path used by a connection between the first network node and a second network node. The connection is established in a transport layer of the first and second network nodes. The transport layer is supported by an IP layer of the first and second network nodes. The first network node manages a second IP path for use by the connection. The first network node is further configured to determine an indication of delay for a packet travelling in the first IP path. The indication relates to time for the packet to travel between the first network node and the second network node. The indication may include a Round Trip Time of the first IP path. Moreover, the first network node is configured to estimate a second derivative of the indication of delay. The second derivative of the indication of delay indicates a rate of change of the indication of delay. Additionally, the first network node is configured to set, based on the second derivative of the indication of delay, a counter for tracking the rate of change of the indication of delay. Furthermore, the first network node is configured to modify the connection to use the second IP path for transmission of packets between the first network node and the second network node, when the counter exceeds a threshold value.

According to a further aspect, the object is achieved by a computer program for managing a first IP path used by a connection between a first network node and a second network node, wherein the computer program comprises computer readable code units which when executed on the first network node causes the first network node to perform the method as disclosed herein.

According to a still further aspect, the object is achieved by a computer program product, comprising computer readable medium and a computer program, as mentioned directly above, stored on the computer readable medium.

Thanks to that the first network node estimates the second derivative of the indication of delay, the first network node is made aware of a rate of change of the indication of delay. Next, the first network node sets, based on the second derivative of the indication of delay, the counter for tracking the rate of change of the indication of delay. When the counter exceeds the threshold value, the first network node modifies the connection to use the second IP path for transmission of packets between the first network node and the second network node. In this manner, the first network node may be able to predict, or estimate, that an upcoming congestion may occur. In response to that the upcoming congestion is predicted to occur, the connection is thus modified to use the second IP path, which may be better, e.g. in terms of lower probability of congestion, than the first IP path. As a result, the above mentioned object is achieved.

Advantageously, the first network node modifies the connection prior to congestion of the first IP path. Thus, impact on traffic on the first IP path may less, e.g. in terms of bitrate, as compared to when the connection is modified after a network failure, such as a congestion, on the first IP path has occurred.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic overview of an exemplifying communications network in which embodiments herein may be implemented,

FIG. 2 is a schematic, combined signaling scheme and flowchart illustrating embodiments of the methods when performed in the communications network according to FIG. 1,

FIG. 3 is a signaling scheme illustrating delay between the first and second network nodes,

FIG. 4 is an exemplifying diagram illustrating delay as a function of time,

FIG. 5 is another exemplifying diagram illustrating delay as a function of time,

FIG. 6 is a further exemplifying diagram illustrating delay as a function of time,

FIG. 7 is a flowchart illustrating embodiments of the method in the first network node, and

FIG. 8 is a block diagram illustrating embodiments of the first network node, the computer program and the computer program product.

### DETAILED DESCRIPTION

Throughout the following description similar reference numerals have been used to denote similar elements, units, modules, circuits, nodes, parts, items or features, when applicable. In the Figures, features that appear in some embodiments are indicated by dashed lines.

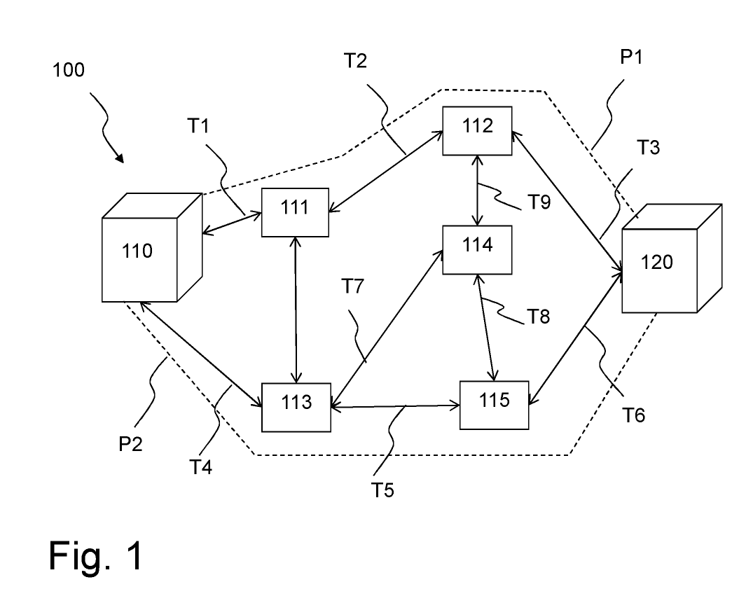

FIG. 1 depicts an exemplifying communications network 100 in which embodiments herein may be implemented.

The communications network 100 comprises a first network node 110 and a second network node 120.

Furthermore, the communications network 100 may comprise a third, a fourth, a fifth, a sixth and a seventh network node 111, 112, 113, 114, 115. Sometimes, these network nodes may be referred to as one or more further network nodes 111-115.

In more detail, the communications network 100 may comprise a transport layer, or transport network, including the first and second network nodes 110, 120. The transport layer may be an SCTP layer. Moreover, the communications network 100 may comprise a so called network layer, such as an IP network, including said one or more further network nodes 111-115 as well as the first and second network nodes 110, 120. This means that the communications network 100 includes two layers, the transport layer, which is connection oriented, and the network layer, which is connectionless. The terms “transport layer” and “network layer” are used as in an Open Systems Interconnection (OSI) model, which is a conceptual model that characterizes and standardizes internal functions of communication systems by partitioning it into abstraction layers. The OSI model is a product of the Open Systems Interconnection project at the International Organization for Standardization (ISO) and International Electrotechnical Commission (IEC). More information about the OSI model may be found in e.g. ISO/IEC 7498-1.

A connection (not shown) may be established between the first network node 110 and the second network node 120. As an example, the connection may be managed by a transport protocol, or transport layer, in the first network node 110. Similarly to the above, the transport protocol may for example be SCTP. For SCTP the connection is often referred to as an association.

In the first network node 110, the transport protocol may be supported by an Internet Protocol (IP) in the first network node 110.

The connection may use one or more IP paths, such as the first IP path P1 and the second IP path P2. As is illustrated in the Figure, the first IP path P1 passes via the third and fourth network nodes 111, 112.

Similarly to the first network node 110, the second network nodes 120 may operate, or manage, a transport layer, or transport protocol.

The connection in the transport layer of the first and second network nodes 110, 120 uses a number of trunks T1-T9, which interconnects the further network nodes 111-115 with each other and the first and second network nodes 110, 120 in an IP network, which is at least in part used by the connection.

Briefly, thanks to the embodiments herein a decision, such as in action 210 below, for changing an active IP path may be made early, i.e. before experiencing a real network failure. Now assume that the communications network 100 offers at least a working IP path between network nodes 110, 120. Then, when the embodiments herein are applied to a multi-homed protocol, such as SCTP, there may seldom, or never, be a network congestion due to that packet loss may be avoided, or at least reduced. That is to say, according to the embodiments herein, traffic loss due to congestion will be avoided or at least reduced. This is achieved by enabling the first network node 110 to avoid IP paths that are predicted to become congested. These IP paths, which potentially may become congested, are avoided in the real time by changing, or moving, the connection such that it uses other IP paths, preferably these other IP paths are not potentially congested.

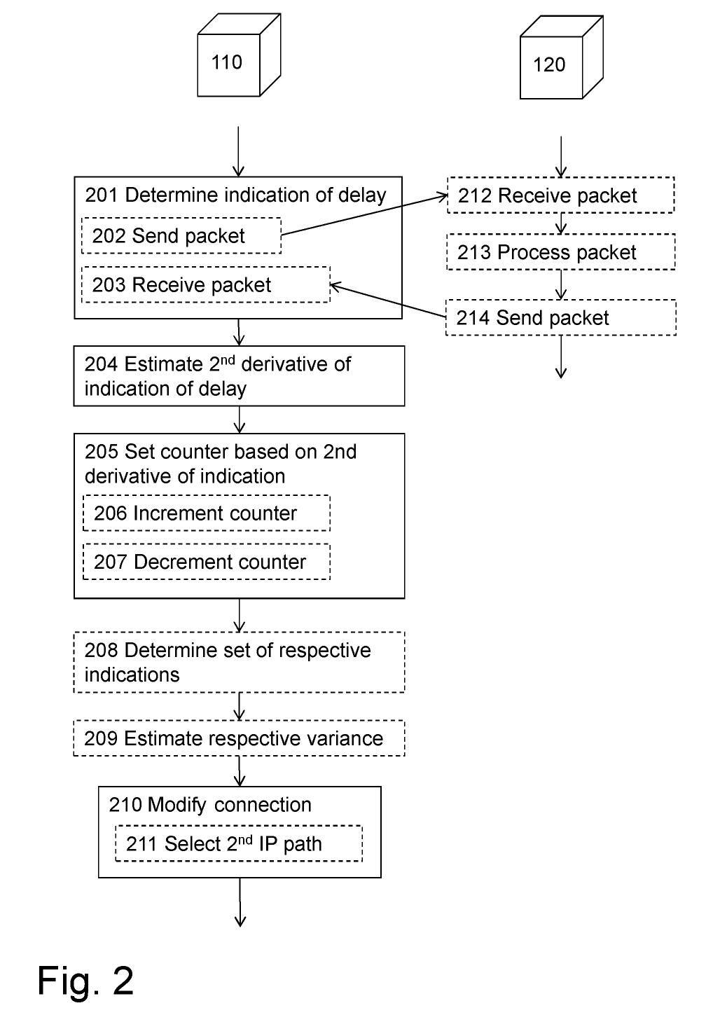

FIG. 2 illustrates an exemplifying method for managing the first IP path P1 used by the connection between the first network node 110 and a second network node 120 when implemented in the communication network 100 of FIG. 1.

The connection is established in a transport layer of the first and second network nodes 110, 120. The transport layer is supported by an IP layer of the first and second network nodes 110, 120. The first network node 110 manages a second IP path P2 for use by the connection, i.e. the second IP path P2 may currently be offline, e.g. not used by the connection. The first network node 110 may also manage one or more further IP paths for use by the connection.

The following actions may be performed in any suitable order.

### Action 201

In order for the first network node 110 to be able to detect congestion before it happens, the first network node 110 begins with determining an indication of delay for a packet travelling in the first IP path. In action 204 the first network node 110 further processes the determined indication. The indication relates to time for the packet to travel between the first network node 110 and the second network node 120.

As an example, the indication may include the time for the packet to travel between the first network node 110 and the second network node 120.

The indication may include a Round Trip Time of the first IP path.

In some examples, the indication may be a heartbeat package, or heartbeat message. This may mean that the indication may be obtained, or implemented, by means of a heartbeat package.

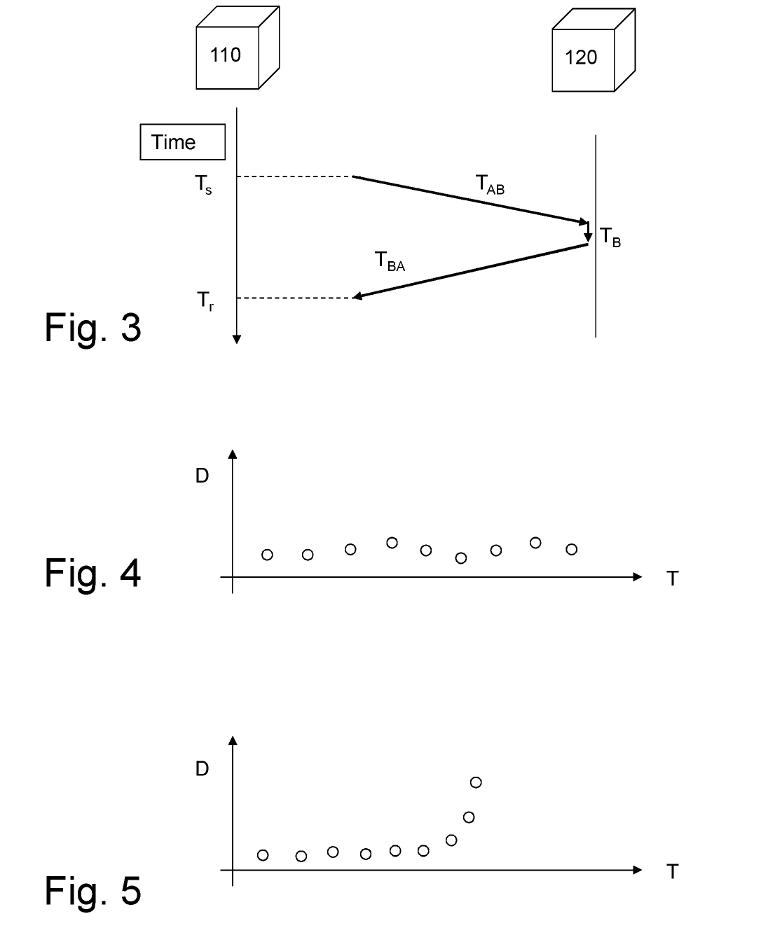

In order to perform action 201, the first network node 110 may perform actions 202 and 203. In these actions, the packet may be used for measuring the delay. See also FIG. 3 below.

### Action 202

The first network node 110 may send, to the second network node 120, the packet at a first measurement point in time. The first measurement point in time may be included in the packet. In some examples, the packet may be a so called heartbeat message. See also FIG. 3 below.

### Action 203

The first network node 110 may receive, from the second network node 120, the packet for measuring the delay at a second measurement point in time.

Hence, when the first network node 110 compares the first and second measurement points in time, the indication of delay may be determined according to action 201. See also FIG. 3 below.

### Action 204

In order to obtain knowledge about a rate of change of the indication of delay, the first network node 110 estimates 204 a second derivative of the indication of delay. Thus, the first network node 110 further processes the determined indication as mentioned above. The second derivative refers to a known mathematical operation, which may include that a first derivative of the indication is determined first. When the first derivate is estimated, the second derivate may subsequently be estimated as in this action. Since the first derivate indicates a change of the indication, the second derivative of the indication indicates the rate of change of the indication of delay. This is further explained with referent to FIGS. 4 to 6 below.

### Action 205

The first network node 110 sets, based on the second derivative of the indication of delay, a counter for tracking the rate of change of the indication of delay. In this manner, the first network node 110 may be able to further utilize the second derivative, estimated at regular or irregular time interval, to keep track the rate of change of the indication. The counter may count a number of observations indicative of exponential growth of the indication. In some examples, the observations may be indicative of polynomial growth. By means of the counter, the first network node 110 may provide an estimate of upcoming congestion, or nearly/approaching congestion, i.e. a level of congestion at the first IP path. The estimate may be considered to be a prediction of that a congestion may occur.

This is also further explained with referent to FIGS. 4 to 6 below.

In action 206 and 207 below, action 205 is further elaborated.

### Action 206

When the second derivative indicates increasing rate of change of delay, the first network node 110 may increment the counter. This may mean that an observation of exponential growth with respect to the indication may have been observed.

As an example, the second derivative indicates an increase of the rate of change of delay when the second derivative is above a first threshold value, being equal to e.g. zero or a positive value for introducing a first margin. The positive value may be set such that some observations, e.g. relatively small observations, i.e. close to zero, may be ignored.

### Action 207

Similarly to action 206, but when the second derivative indicates decreasing rate of change of delay, the first network node 110 may decrement 207 the counter.

This may mean that an observation of exponential decay with respect to the indication may have been observed.

As an example, the second derivative indicates a decrease of the rate of change of delay when the second derivative is above a second threshold value, being equal to e.g. zero or a negative value for introducing a second margin. The negative value may be set such that some observations, e.g. relatively small observations, i.e. close to zero, may be ignored.

In response to that the first network node 110 may have set the counter, in action 205 and possibly as elaborated in action 206 and/or 207, the first network node 110 may perform action 201 and/or 204 more frequently when one or more observations of exponential growth have been detected. Therefore, the first network node 110 may perform action 201 and/or 204 at a time interval, which is dependent on the counter. Accordingly, action 201 and/or 204 may be performed less frequently when one or more observations of exponential decay have been detected.

In order to characterize offline IP path quality, i.e. quality of IP paths that are not currently used by the connection, the first network node 110 may perform actions 208 and 209. The offline IP paths may be included in a set of IP paths, which may include the second IP path. It shall be understood that the set of IP paths may in many examples include further IP paths than merely the second IP path.

### Action 208

Hence, to obtain an offline IP path quality, the first network node 110 may determine a set of respective indications of respective delays for one or more packets travelling in each of the IP paths of the set of IP paths. Each of the respective indications relates to time for each of said one or more packets to travel between the first network node 110 and the second network node 120.

As an example, each of the respective indications may include the time for each of said one or more packets to travel between the first network node 110 and the second network node 120.

The determination of the set of respective indications of respective delay may be performed by means of heartbeat messages similarly to how the indication of delay is determined for the first IP path.

In order to illustrate how the term “respective” is used above, let's assume that the set of respective indications of respective delays may comprise a first indication of delay in an IP path “X” and a second indication of delay in an IP path “Y”. In this example, the set of IP paths may comprise the IP path “X” and the IP path “Y”. Thus, the first indication relates to delay of packets travelling in the IP path “X” and the second indication relates to delay of packets travelling in the IP path “Y”.

### Action 209

The first network node 110 may estimate a respective variance for each respective indication of respective delays. The respective variance may be used as a measure of offline path quality in action 211.

### Action 210

When the counter, which was set in action 205, exceeds a threshold value, the first network node 110 modifies 210 the connection C1 to use the second IP path for transmission of packets between the first network node 110 and the second network node 120.

However, when the counter does not exceed the threshold value, the counter may indicate that a level of congestion. For example, a percentage may be used to indicate a level of congestion and it is only when the counter is above the threshold that the level of congestion reaches 100% and thus an upcoming congestion is expected.

As an example, the threshold value may be used for detection of an upcoming congestion, e.g. as indicated by increasing delay in the first IP path, i.e. the threshold value may be set such that detection of the upcoming congestion is possible.

As another example, the threshold may be set to 3, which would for example indicate that three observations of exponential growth may be interpreted as the indication of delay is growing exponentially. Thus, it is expected that the upcoming congestion will occur. As mentioned above, the first network node 110 accordingly modifies the connection to use the second IP path instead of, or possibly in addition to, the first IP path.

The term “upcoming” may be understood as that if action 201 is performed at a first point in time, then the upcoming congestion occurs, or may possibly occur, after the first point in time.

### Action 211

In some embodiments, there may be a set of IP paths that are not used, i.e. there are a number of offline IP paths to choose between. For these offline IP paths, a set of variances may include each respective variance. The set of respective indications may include a respective indication for each IP path of the set of IP paths,

Hence, the first network node 110 may select the second IP path out of the set of IP paths e.g. based on the respective variances. As an example, the respective variance for the respective indication of the second IP path is among the least of the set of respective variances. As a further example, the respective variance for the respective indication of the second IP path is the least of the set of respective variances.

In other examples, an IP path corresponding to one of some respective variances which are below a certain threshold value for variance is selected for use by the connection. The threshold value for variance may be calculated as the average of the set of variances.

The characterization of the offline path quality, as in action 208 and 209, and the use thereof, in action 211, is further described in section “Offline Path Quality characterization” below.

With the embodiments relating to offline quality characterization, the first network node 110 is able to, while e.g. using the connection oriented transport layer, to choose, or select, among the IP paths of the set of IP paths according to an estimated path quality, e.g. given by the respective variances. Thus, it may be guaranteed that a switch, e.g. by means of the modification of the connection, will be towards an IP Path that provides better quality characteristics as compared to the present, e.g. the first IP path. Better quality characteristics, e.g. on IP paths that is not congested, may be that the variance is less. In this manner, it may be avoided that the selected IP path, such as the second IP path, causes traffic disturbances because of the switch thereto.

Moreover, the first network node 110 operates a smart traffic redistribution, or adaption, over the connections when the connection experiences an increase of traffic, which ultimately may lead to congestion. Hence, the first network node 110 may utilize the communications network 100 more efficiently by selecting the less used IP paths, such as the second IP path, dynamically.

### Action 212

The second network node 120 may receive the packet sent by the first network node 110 in action 202.

### Action 213

The second network node 120 may process the received packet, e.g. in order to achieve a higher accuracy in the determination of the delay, which determination is performed by the first network node 110 in action 201 above.

Thus, the indication may include a value indicating time spent in the second network node 120. Expressed differently, following action 203, the received packet may include the value indicating time spent in the second network node 120.

As an example, the value may be an in-node value indicative of time spent by the packet in the second network node 120, i.e. the value may be said to indicate the time spent in intermediate network nodes' queues. The second network node 120 may determine the in-node value, since the second network node 120 may be aware of processing load, queue lengths etc. in the second network node 120. Thus, the in-node value may depend on processing load, or processor load, of the second network node 120, number of packets in queue to the second network node 120. In relation to action 203, the packet may include the in-node value. This embodiment is further described in section “accurate determination of D” below.

### Action 214

The second network node 120 may send the packet to the first network node 110. In this manner, the first network node 110 may be informed about the in-node value, if determined by the second network node 120.

According to the embodiments herein, a connection oriented protocol, such as the transport layer of the first network node 110, is able to switch out from a certain IP Path that is showing early symptoms of a congestion, i.e. increasing rate of change of packet delays as indicated by the second derivate of indication, rather than symptoms of a congestion, i.e. packet loss, thus the switch may performed before any traffic disturbance occurs.

FIG. 3 shows a signaling diagram illustrating a procedure for measuring a delay of packets between the first network node 110, A and the second network node 120, B. In this example, the packet is referred to as a heartbeat message.

The first network node 110 may obtain a total transmission time D, or delay, by calculating the difference between the transmission time Tₛ and the reception time Tᵣ. In order to the first network node 110 to be able to determine the total transmission time D, the heartbeat message comprises the transmission time Tₛ as a timestamp. The Figure shows the time spent for a heartbeat message to complete a path from the first network node 110 to the second network node 120 and back again, e.g. while the packet follows one particular IP path.

D=Tᵣ−Tₛ=T_{AB}+T_{B}+T_{BA} Equation 1:

T_{AB} is the time spent by the heartbeat message in the IP Path from the first network node 110 to the second network node 120, T_{B} is the time spent by the heartbeat message in the second network node 120 before being sent back, T_{BA} is the time spent by the heartbeat message in the IP Path from the second network node 120 to the first network node 110, and Tᵣ is the time of the arrival of heartbeat message back to the first network node 110.

Increase of traffic in the network causes increase in T_{AB} and/or T_{BA} timing, resulting in increasing the overall D time.

Since the increase of the time D reflects the time spent in the queues and/or processing load in the second network node 120, it may be used for early detection of network congestions. Heartbeat is sent over all IP paths belonging to the multi-homed connection aka association in rfc4960. For each IP path, offline paths as well as used IP paths, an IP Path Early Congestion indication may be calculated. The IP Path Early Congestion indication may indicate by true or false whether or not the counter has exceeded the threshold in action 205. The IP Path Early congestion indication may thus be expressed as an indication for early detection of congestion of an IP path, such as the first IP path.

Calculation on whether the network is going to get congested exploits the expected behaviour for the indication, e.g. a calculated D.

During normal conditions, the indication is expected to change in linear way. Thus, increase and decrease of the indication as a function of the time will be linear. Clearly, the second derivative will be zero.

If the network gets congested, the indication is expected to increase in exponential way, due to the accumulation in the network element's queues. Clearly, the second derivative will be positive

FIG. 4 illustrates a set of values of D for a non-congested network. Since the values of D are not increasing exponentially no congestion is expected, or predicted.

FIG. 5 illustrates a set of values for a network that may become congested. Since the values of D are increasing exponentially, or almost exponentially, an upcoming congestion is expected.

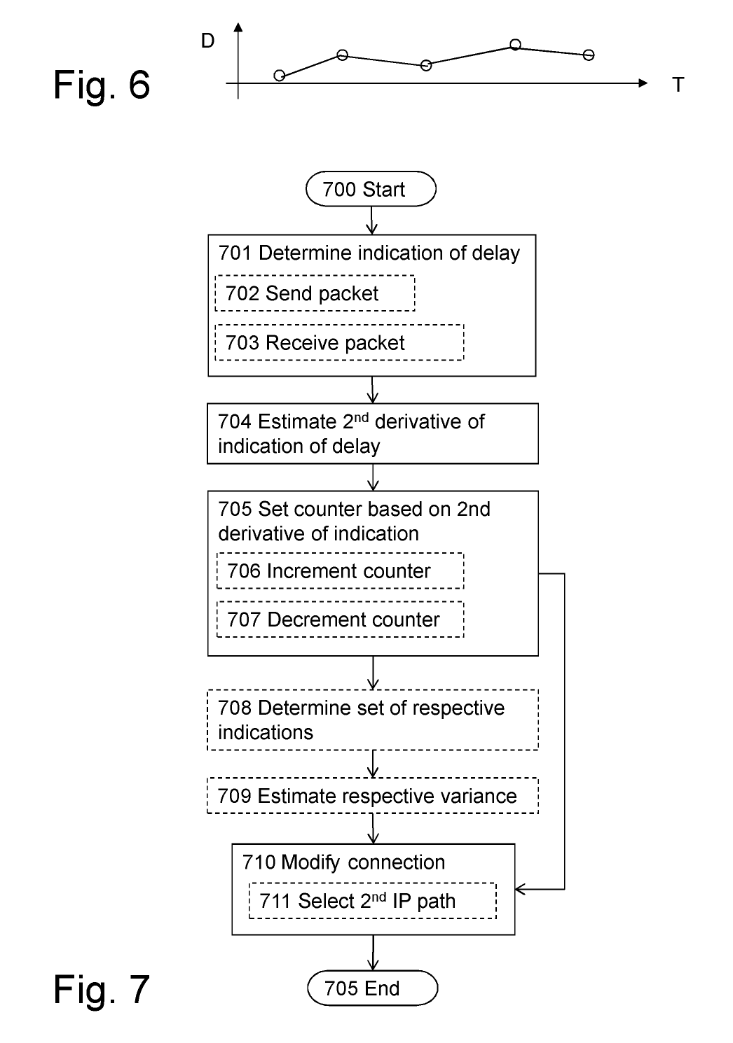

FIG. 6 illustrates in more detail, how the second derivative may be obtained in one exemplifying manner.

Looking at FIG. 6, each measured point ‘o’ may be addressed with the coordinates D, T. Each point may then be connected with the preceding one and the next one by means of two segments

A segment is described with 4 values, T₁,D₁ as initial values, T₂, D₂ as final values.

The segment itself between T₁ and T₂ has grown rate gₜ according to the well-known formula, similar to a first derivative in mathematics:

$${g}_{t} = \frac{( {D}_{2} - {D}_{1} )}{( {T}_{2} - {T}_{1} )} \qquad Equation 2$$

The value of gₜ shows a growth speed of D, i. e. a change of the delay value with respect to time.

By comparing consecutives values of gₜ, the network behaviour, e.g. the first IP path's behaviour, may be evaluated.

A positive value of gₜ means that the delay has increased within the observation time, with a speed given by Equation 2 above. The next value of gₜ can be:
1. Less than gₜ: the delay is growing with lower positive acceleration, e.g. the second derivative of the indication is negative.
2. The same as gₜ: the delay is growing with constant ratio, e.g. the second derivative of the indication is zero.
3. More than gₜ: the delay is growing higher positive acceleration, e.g. the second derivative of the indication is positive.

If the observed values of gₜ, e.g. a first derivative of the indication, show that gₜ is increasing, the path may experience an increase of the delay in an exponential way.

A negative value of gₜ means that the delay has decreased within the observation time, with the speed given by Equation 2 as mentioned above. The next value of gₜ can be:
1. Less than gₜ: the delay is decreasing with faster negative acceleration, e.g. the second derivative of the indication is negative.
2. The same as gₜ: the delay is decreasing with constant ratio, e.g. the second derivative of the indication is zero.
3. More than gₜ: the delay is decreasing with lower negative acceleration, e.g. the second derivative of the indication is positive.

If the observed values of gₜ, e.g. a first derivative of the indication, show that gₜ is decreasing, the path may experience a decrease of the delay in an asymptotical way. Notably, the second derivative would be positive, but should not be taken into account since D decreases.

In FIG. 6, it's shown how the calculated D is being used for providing an early indication, such as the counter, of whether the first IP path is about to become congested, or possibly is about to become congested.

Detection of an exponential trend in, or among, the D values as function of T may be obtained as a result from calculating gₜ as above and comparing a latter gₜ with an earlier gₜ₋₁ and recording such comparison by setting the counter as in action 205. The counter is then checked against the threshold value for deciding whether or not to switch to an alternative IP path, e.g. as in action 210.

The threshold value may be chosen depending on the frequency of the heartbeat messages and will describe the consecutives positive changes of gₜ that will trigger the first network node 110 to perform action 210.

Since an exponential trend in the measured delay may quickly result in a congested network, a safe approach may be to increase the frequency of D measurement, e.g. decrease the time interval between repetitive executions of action 201, when a positive second derivative of the indication is detected. In this manner, the first network node 110 may be able to take action, such as action 210, more quickly in response to network degradation.

It's possible that the exponential trend in D values is a temporary condition, and that the threshold is not reached by the counter, still a proper handling of such situation is needed for avoiding false detection. The criteria for decreasing the counter is similar to the one used for increase, thus a negative change of gₜ will cause the counter to be decreased.

As long as the counter value is greater than zero, the absolute delay value D is compared with a Reset Threshold:

The counter may be reset to zero if it is less than that the Reset Threshold. The Reset Threshold is calculated starting from a minimum measured delay.

Based on comparisons of IP Path Quality, e.g. in terms of whether or not the counter has exceeded or reached the threshold, the first network node 110 may take a decision about moving the connection from an IP Path that is deteriorating towards another IP Path that provides better characteristics.

In case of so called concurrent multipath enabled protocols, where a set of IP Paths is used simultaneously, the IP Path Early congestion indication may be used for dividing that set into two subsets, where the connection will use only a subset that shows IP Path Early congestion indication not set, i.e. FALSE, and moving IP Paths among the two subsets dynamically.

The way the first network node 110, i.e. a multi-homed protocol executed within the first network node 110, implements the moving from using an IP Path to another is dependent on how the protocol is designed.

For SCTP it's possible either to use the IP Path Early indication for stepping up and down an Path Max Retrans (PMR) counter according to known SCTP terminology. Alternatively, a new Path Quality Counter is introduced that is used together with PMR for deciding whether to change the active IP path, i.e. the first IP path.

### Offline Path Quality Characterization

As seen above, an early detection of network quality degradation would permit the multi-homed protocol to switch from an IP Path that would eventually get congested towards another IP Path that is not experiencing an exponential growth in the measured delay. Even though the criteria for switching from a path with such bad measured quality are sufficient, a better evaluation needs to be made for choosing the destination IP Path.

The proposed method for Offline Path Quality characterization is based on statistics on the IP Path measurements in a certain observation window, which would permit estimation on how the network is expected to behave.

The measurements are the same as used for early congestion detection according to e.g. action 201, thus the studied effect is still the Round Trip Time of Heartbeats, but they are analysed with statistic tools.

In a sequence of observations of D for non-congested IP Path, it's expected that the value of D will be distributed between a certain minimum value Dₘᵢₙ and a certain maximum value Dₘₐₓ that depend on the characteristics of the network and the traffic on that IP Path. The distribution will have statistic characteristics like the average

$$M = \frac{1}{n} {\sum }_{i = 1}^{n} {x}_{i} \qquad Equation 3$$

and the variance

$${σ}^{2} = \frac{{\sum }_{i = 1}^{n} {x}_{i}^{2}}{n} - {( \frac{{\sum }_{i = 1}^{n} {x}_{i}}{n} )}^{2} \qquad Equation 4$$

The average of D value has little meaning, as it depends also on the number of nodes along the path, thus an IP Path with average value of D that is less than the average value of another IP Path doesn't mean that the first IP Path is to be preferred.

As an example, a longer IP path, that comprises by a higher number of trunks and nodes, normally has a higher average delay than a shorter IP path. A reason for this is that for each node that is passed at least a small delay is paid, or required, for the processing in the node being passed. However, such longer IP path may have a lower variance than the short IP path because all, or most of, the nodes in the longer IP path have shorter queues than all, or most of, the nodes in the short IP path. Thus, it is better to choose the longer IP path, since shorter queues imply less risk of congestion on the longer IP path.

Accordingly, the variance of D represents a more interesting data, as higher variance describes that there are events happening on that IP Path that result in high impact on either the offered bandwidth of some of the intermediate nodes or in the presence of very high traffic burst that affect parts of the IP Path.

Since the variance is an absolute value, variance belonging to different IP Path can be compared, and the Variance of D can be used as IP Path Quality characterization criteria.

When using variance as measure for characterization of IP Path Quality, a size, or length in time, of an observation window may be the same for all IP paths for which IP path quality is to be characterized. The observation window shall also preferably be close in time to the decision time, such as action 211 when the counter may be compared to the threshold. On the other hand, estimation of variance, as in action 209, is only needed during the switchover, similarly to in action 211. Thus, the calculation, or estimation as is action 209, may be done only when needed.

Once decided the observation window size s, an array of s elements will be kept updated per each IP Path containing the last s measured values of D. Whenever a switchover from the current IP Path is requested, the variance will be calculated for all the IP Paths, and the IP Path having e.g. the minor value of Variance may be chosen.

### Accurate Determination of D

As described in Equation 1 above, the value of D is built as the contribution of 3 stochastic variables, where T_{AB} and T_{BA} describe the network contribution to the delay and T_{B} describes the contribution of the second network node 120 computational resources.

Since T_{B} indicates time not spent in the network, its contribution should be removed from D, but since T_{AB}, T_{B} and T_{BA} cannot be measured separately without introducing a dedicated interwork between A and B, the contribution of T_{B} needs to be considered.

Each and all IP Paths used by the multi-homed protocol have in common the second network node 120, thus each and all measured D for any IP path between the first and second network node 110, 120 will be subject to the contribution of T_{B} at the same time.

Due to the contribution of T_{B}, all the different D measured on all IP Paths will be affected by variations in the timing spent in the second network node 120, resulting in less accurate results.

If the value of T_{B} increases exponentially, or maybe in a polynomial manner, during a reasonable long time, the resulting D value can be interpreted as potential network congestion.

Since T_{B} affects all different IP Paths, in case of potential network congestion due to T_{B}, all the various IP Paths will be suspected for potential congestion at the same time. Thus, a false detection of that all IP paths that the connection may use will possibly be congested. In this case, it's not possible to decide whether to switch to another IP Path, because all the IP Paths provide the same indication, and there's no way for understanding whether this is due to T_{B} contribution or other network conditions.

If the problem is only due to the second network node 120, there is not real network problem at all. However, if the problem in the second network node 120 happens simultaneously with another real network failure in the IP Path that is being used, there's no other solution than relying on the existing protocol Congestion Recovery procedures.

Another problem caused by the contribution of T_{B} to D is the effect on statistics when changes in T_{B} are so quick that they influence the measurements related to the various IP Paths independently, in that case the contribution of T_{B} on each IP Path will be visible in average and variance calculations, this can cause a defective IP Path selection when an IP Path switch is decided. The problem can be moderated by adding a criterion involving the average delay in the decision, meaning that whenever all measured IP Paths would have similar values in variance, the one with minimum average delay may be chosen, or may be preferred.

### Accurate D Measurement

An accurate D measurement means that the value of D only contains the network contribution, i.e. in that case the Equation 1 still applies but T_{B} is zero.

In that case, the heartbeat part of the multi-homed protocol requires to be designed in a way that permits the first network node 110 to remove T_{B} contribution from the measurement, by reading the value of T_{B} from the second network node 120.

For example, the heartbeat message may further include an indication of T_{B}, or the actual value of T_{B}. Such change in the protocol requires the heartbeat packet to be standardized in format, in order to transport values that are understood at either site of the IP Path independently on the host's architectures.

The contribution of T_{B} may be taken into account according to the following two exemplifying embodiments; a first embodiment and a second embodiment.

In the first embodiment, the second network node 120 simply recalculates the timestamp in the heartbeat message by adding the time spent in the second network node 120, so that the timestamp value will be

T_{s′}=Tₛ+T_{B} Equation 5

Thus the calculation of D will not be affected by T_{B} contribution.

In the second embodiment, the heartbeat message is structured so that it comprises Information Fields and Data Fields. The first network node 110 will then provide a request to the second network node 120 in order to obtain the desired information on the data.

With the second embodiment, D is calculated according to

D=T_{R}−(T_{S}+T_{B}) Equation 6

The adoption of accurate D measurement, as said above, requires the multi-homed protocol to implement the heartbeat in a standardized way as is exemplified in section “backward compatible heartbeat protocol” below.

### Heuristic D Improvement

It is possible to improve the D value used in Equation 2 by removing from it a part that is with a large probability larger than T_{B} contribution.

Assuming that the multi-homed association is built up with n independent IP Paths, assuming that the value of T_{B} affects all IP Paths in the same way within a certain measurement, and listing the n measured values of D as D₁, D₂, . . . , Dₙ with Dₘ being the minor, we can say that

T_{B}<Dₘ

where Dₘ=T_{B}+Nₘ
where Nₘ is the Network Delay contribution to Dₘ.

If we subtract Dₘ from all the Dₓ obtained within a measurement involving all the independent IP Paths, we will obtain new delay values that will not contain the T_{B} contribution. The new formula is

DFₓ=Dₓ−Dₘ, where DFₓ is the filtered value of Dₓ for the x^{th} IP Path.

The calculated DF will replace D in Equation 2.

Increases in T_{B} that can lead to wrong result from the algorithm are thus removed.

The improvement only permits to filter out false network congestions due to T_{B} contribution, still variation of TB that affect the IP Paths independently are not removed.

### Backwards Compatible Heartbeat Protocol

Due to potential problems when adopting a protocol independent measurement, and because of the need to interoperate with nodes, such as the first and second network nodes 110, 120, that may not fully adopt a standard solution, it's suggested to introduce in multi-homed protocols a backwards compatible implementation of Heartbeat.

An assumption is that the multi-homed protocol already supports a heartbeat mechanism where the second network node 120 simply sends back the Heartbeat packet to the first network node 110, as for instance SCTP.

The first network node 110 will use a structured format for HB packet, that contains a field indicating the OPERATION, a field that contains Tₛ, a field that contains the ANSWER and a field that contains T_{B}.

The first network node 110 will fill OPERATION with a value TB_REQ indicating to the second network node 120 to fill the TB field with the actual value, the ANSWER filed will be set to NONE and the T_{B} field will be set to zero.

If the second network node 120 is aware of the HB Protocol, it will understand the TB_REQ and will write TB_ACK in the ANSWER field, then it will write the actual value of T_{B} in the proper field of the HB packet and relay the packet back to the first network node 110.

If the second network node 120 is not aware of the HB Protocol (for instance rfc4960), it will simply relay the HB packet back to the first network node 110.

When the first network node 110 will obtain back the HB packet, it will check the ANSWER field, and behave differently dependent on the contents. If ANSWER is equal to NONE, then the Equation 1 will be used, otherwise if ANSWER is equal to TB_ACK then the Equation 6 will be used instead.

### Example of a Multi-Homed Association

The following table shows an example where an SCTP host is multi-homed, and has an Association towards a remote SCTP host. Both hosts have two IP addresses

TABLE 1
Example of SCTP multi-homed association

| | | | | | IP Path |
|---|---|---|---|---|---|
| | | | | | Early |
| Association | | | HB | | congestion |
| Id | Local IP | Remote IP | Failures | Active | Indication |
| A1 | 10.0.1.4 | 192.168.6.8 | 0 | Y | FALSE |
| | 10.0.1.5 | 192.168.6.8 | 0 | N | FALSE |
| | 10.0.1.4 | 192.168.6.9 | 0 | N | FALSE |
| | 10.0.1.5 | 192.168.6.9 | 0 | N | TRUE |

The columns in the table describe the Association ID, and for each IP path a row contains the local and remote IP addresses, the current Heartbeat failures, the information whether the IP path is the one active and the calculated IP Path Early congestion indication as a Boolean variable, being able to take the values true or false.

The SCTP host implements the multi-homed association A1 using two IP ports towards a remote SCTP host that also uses two IP addresses. Four IP paths are described for the association. On each path SCTP computes the Heartbeat health itself, as described in rfc4960, and then the IP Path Early congestion indication. The active path is using 10.0.1.4→←4192.168.6.8 and is experiencing good network characteristics.

In FIG. 7, an exemplifying, schematic flowchart of a method performed by the first network node 110 is shown. As mentioned, the network node 110 performs a method for managing a first Internet Protocol, “IP”, path P1 used by a connection between the first network node 110 and a second network node 120.

As mentioned, the connection is established in a transport layer of the first and second network nodes 110, 120. The transport layer is supported by an IP layer of the first and second network nodes 110, 120. The first network node 110 manages a second IP path P2 for use by the connection.

### State 700—Start State

Initially, the first network node 110 may, as mentioned above, already have established the connection between the first and second radio network node 110, 120 while using the first IP path for carrying messages, or data, over the connection.

In addition, the first network node 110 may have set up one or more further IP paths, such as the second IP path, that may be used by the connection. However, such one or more further IP paths are currently not used by the connection, i.e. these IP paths are offline.

The following actions may be performed in any suitable order.

### Action 701

The first network node 110 determines an indication of delay for a packet travelling in the first IP path. The indication relates to time for the packet to travel between the first network node 110 and the second network node 120.

As mentioned, the indication may include a Round Trip Time of the first IP path.

This action is similar to action 201.

### Action 702

In order to determine the indication, the first network node 110 may send, to the second network node 120, the packet at a first measurement point in time. This action is similar to action 202.

### Action 703

The first network node 110 may receive, from the second network node 120, the packet for measuring the delay at a second measurement point in time. This action is similar to action 203.

### Action 704

The first network node 110 estimates 204 a second derivative of the indication of delay. The second derivative of the indication of delay indicates a rate of change of the indication of delay.

The determining 201 of the indication of delay and the estimating 204 of the second derivative of the indication of delay may be performed at a time interval, which is dependent on the counter.

This action is similar to action 204.

### Action 705

The first network node 110 sets based on the second derivative of the indication of delay, a counter for tracking the rate of change of the indication of delay. This action is similar to action 205.

### Action 706

In more detail of action 705, the setting of the counter may comprise incrementing the counter when the second derivative indicates increasing rate of change of delay. This action is similar to action 206.

### Action 707

In more detail of action 705, the setting 205 of the counter may comprise decrementing the counter when the second derivative indicates decreasing rate of change of delay. This action is similar to action 207.

### Action 708

In some examples, a set of IP paths includes the second IP path. The first network node 110 may determine a set of respective indications of respective delays for one or more packets travelling in each of the IP paths of the set of IP paths, wherein each of the respective indications relates to time for each of said one or more packets to travel between the first network node 110 and the second network node 120. This action is similar to action 208.

### Action 709

The first network node 110 may estimate a respective variance for each respective indication of respective delays. This action is similar to action 209.

### Action 710

The first network node 110 modifies the connection C1 to use the second IP path for transmission of packets between the first network node 110 and the second network node 120, when the counter exceeds a threshold value. This action is similar to action 210.

### Action 711

In some embodiments, a set of variances may include each respective variance. The set of respective indications may include a respective indication for each IP path of the set of IP paths. The modifying 710 of the connection may comprise selecting the second IP path out of the set of IP paths. The respective variance for the respective indication of the second IP path is among the least of the set of respective variances. Alternatively, the respective variance for the respective indication of the second IP path is the least of the set of respective variances.

The indication may include a value indicating time spent in the second network node 120. Expressed differently, following action 203, the received packet may include the value indicating time spent in the second network node 120.

This action is similar to action 211.

### State 712—an End State

The first network node 110 may at this point be ready to return to action 701 to repeatedly, e.g. at a regular or irregular time interval, perform one or more of the actions described above. The actions may be performed occasionally or periodically. Moreover, the first network node 110 may wait, e.g. according to the regular or irregular time interval, before returning to action 701 or the first network node 110 may immediately return to action 701.

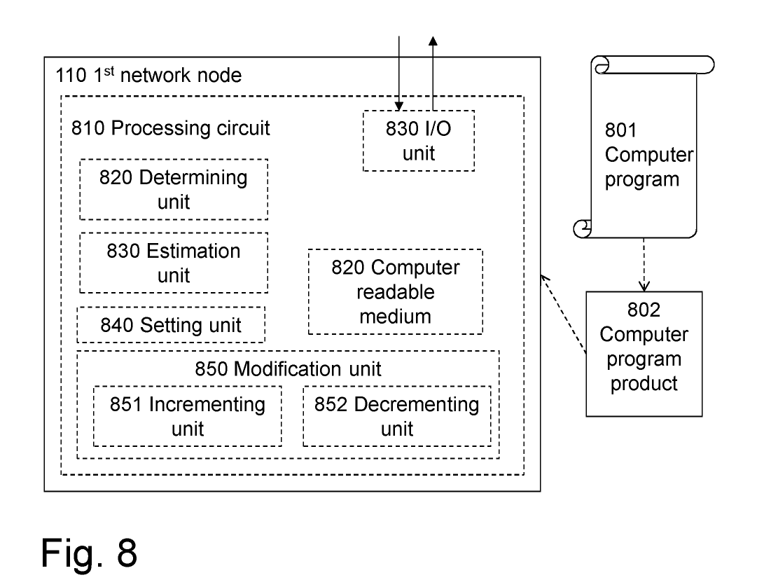

With reference to FIG. 8, a schematic block diagram of the first network node 110 is shown. The first network node 110 is configured to perform the methods in FIG. 2 and/or 7. Thus, the first network node 110 is configured to manage a first Internet Protocol, “IP”, path P1 used by a connection between the first network node 110 and a second network node 120. The connection is established in a transport layer of the first and second network nodes 110, 120. The transport layer is supported by an IP layer of the first and second network nodes 110, 120. The first network node 110 manages a second IP path P2 for use by the connection.

In a first example, the first network node 110 may comprise a processing circuit 810 configured to perform the methods described with reference to FIG. 2 and/or 7. Moreover, the first network node 110 may comprise a computer readable medium 820 and/or and an Input/Output (I/O) unit 830. The computer readable medium 820 and the I/O unit 830 will be described further below.

In a second example, the first network node 110 may comprise dedicated units configured to perform one or more actions as described with reference to FIG. 2 and/or 7. The dedicated units are shown in FIG. 8 and will be described below.

The first network node 110 is configured to determine an indication of delay for a packet travelling in the first IP path. The indication relates to time for the packet to travel between the first network node 110 and the second network node 120. The indication may include a Round Trip Time of the first IP path. The indication may include a value indicating time spent in the second network node 120.

In the first example, the processing circuit 810 may be configured to determine the indication of delay.

In the second example, the first network node 110 may comprise a determining unit 820, which may be configured to determine the indication of delay.

Moreover, the first network node 110 is configured to estimate a second derivative of the indication of delay. The second derivative of the indication of delay indicates a rate of change of the indication of delay.

In the first example, the processing circuit 810 may be configured to estimate the second derivative of the indication of delay.

In the second example, the first network node 110 may comprise an estimation unit 830, which may be configured to estimate the second derivative of the indication of delay.

Additionally, the first network node 110 is configured to set, based on the second derivative of the indication of delay, a counter for tracking the rate of change of the indication of delay.

In the first example, the processing circuit 810 may be configured to set the counter for tracking the rate of change of the indication of delay.

In the second example, the first network node 110 may comprise a setting unit 840, which may be configured to set the counter for tracking the rate of change of the indication of delay.

Furthermore, the first network node 110 is configured to modify the connection C1 to use the second IP path for transmission of packets between the first network node 110 and the second network node 120, when the counter exceeds a threshold value.

In the first example, the processing circuit 810 may be configured to modify the connection C1.

In the second example, the first network node 110 may comprise a modification unit 850, which may be configured to modify the connection C1.

The first network node 110 may be configured to set the counter by further being configured to increment the counter when the second derivative indicates increasing rate of change of delay, and to decrement the counter when the second derivative indicates decreasing rate of change of delay.

In the first example, the processing circuit 810 may be configured to set the counter by further being configured to increment the counter when the second derivative indicates increasing rate of change of delay, and to decrement the counter when the second derivative indicates decreasing rate of change of delay.

In the second example, the modification unit 850 may comprise an incrementing unit 851, which may be configured to increment the counter when the second derivative indicates increasing rate of change of delay, a decrementing unit 852, which may be configured to decrement the counter when the second derivative indicates decreasing rate of change of delay.

The first network node 110 may further be configured to determine the indication of delay and estimate the second derivative of the indication of delay at a time interval, which is dependent on the counter.

In the first example, the processing circuit 810 may be configured to determine the indication of delay and estimate the second derivative of the indication of delay at a time interval, which is dependent on the counter.

In the second example, the determining unit 820 may be configured to determine the indication of delay at a time interval, which is dependent on the counter, and the estimation unit 830 may be configured to estimate the second derivative of the indication of delay at the time interval.

In some embodiments, a set of IP paths may include the second IP path. In these embodiments, the first network node 110 may further be configured to determine a set of respective indications of respective delays for one or more packets travelling in each of the IP paths of the set of IP paths, wherein each of the respective delays includes time for each of said one or more packets to travel between the first network node 110 and the second network node 120, and to estimate a respective variance for each respective indication of respective delays.

In the first example, the processing circuit 810 may be configured to determine the set of respective indications of respective delays and to estimate the respective variance for each respective indication.

In the second example, the determining unit 820 may further be configured to determine the set of respective indications of respective delays and the estimation unit 830 may be configured to estimate the respective variance for each respective indication.

In some embodiments, a set of variances may include each respective variance. The set of respective indications may include a respective indication for each IP path of the set of IP paths. The first network node 110 may be configured to modify the connection by being configured to select the second IP path out of the set of IP paths.

The respective variance for the respective indication of the second IP path may be among the least of the set of respective variances. Alternatively, the respective variance for the respective indication of the second IP path may be the least of the set of respective variances.

In the first example, the processing circuit 810 may be configured to modify the connection by being configured to select the second IP path out of the set of IP paths.

In the second example, the modification unit 850 may further be configured to select the second IP path out of the set of IP paths.

The computer readable medium 820 may be configured to store a computer program 801 for managing the first IP path P1 used by the connection between the first network node 110 and the second network node 120. The computer program 801 may be, e.g., in the form of software, to be executed by, for example, the first network node 110 and/or the processing circuit. The computer program 801 may comprise computer readable code units, such as instructions, to enable the processing circuit to perform the method in the first network node 110 as described above in conjunction with FIG. 2 and/or 7. Expressed differently, when executed by the first network node 110 or by the processing circuit, the computer readable code units causes the first network node 110 to perform the method according to embodiments herein. The computer readable medium may be a hard disk, a magnetic storage medium, a portable computer diskette or disc, flash memory, random access memory (RAM) or the like. Furthermore, the computer readable medium may be an internal register memory of a processor. The software may be in the form of binary code, machine code, source code and/or any intermediate forms of codes or any combination of the aforementioned codes. Any intermediate forms of codes may be between e.g. binary code and machine code, machine code and source code etc.

The I/O unit 830 may be configured to send and/or receive the indication, the packet etc. and/or other numbers, values, messages as described herein according various embodiments. The I/O unit 830 may comprise a transmitter and/or a receiver. In some examples, the transmitter may be a radio transmitter for transmission of data over a radio interface and/or the receiver may be a radio receiver for reception of data over a radio interface. The radio interface may be defined in a Radio Access Network (RAN), such as a Third Generation Partnership Project (3GPP) RAN, including e.g. UMTS Terrestrial Radio Access Network (UTRAN) networks, where UTMS is short for Universal Mobile Telecommunications System, Evolved-UTRAN (E-UTRAN) or the like.

In other examples, the transmitter and/or receiver may operate according to various communication standards, such as Message Transfer Part of Signaling System 7, Ethernet or the like.

Furthermore, FIG. 8 illustrates a computer program product 802, comprising computer the readable medium 820 and the computer program 801, stored on the computer readable medium 820.

As used herein, the expression “in some embodiments” has been used to indicate that the features of the embodiment described may be combined with any other embodiment disclosed herein.

As used herein, the expression “transmit” and “send” are considered to be interchangeable. These expressions include transmission by broadcasting, uni-casting, group-casting and the like. In this context, a transmission by broadcasting may be received and decoded by any authorized device within range. In case of uni-casting, one specifically addressed device may receive and encode the transmission. In case of group-casting, a group of specifically addressed devices may receive and decode the transmission.

Even though embodiments of the various aspects have been described, many different alterations, modifications and the like thereof will become apparent for those skilled in the art. The described embodiments are therefore not intended to limit the scope of the present disclosure.

1. A method, performed by a first network node, for managing a first Internet Protocol (IP), path used by a connection between the first network node and a second network node, wherein the connection is established in a transport layer of the first and second network nodes, wherein the transport layer is supported by an IP layer of the first and second network nodes, wherein the first network node manages a second IP path for use by the connection, and wherein the method comprises:
determining an indication of delay for a packet travelling in the first IP path, wherein the indication relates to time for the packet to travel between the first network node and the second network node;
estimating a second derivative of the indication of delay, wherein the second derivative of the indication of delay indicates a rate of change of the indication of delay;
setting, based on the second derivative of the indication of delay, a counter for tracking the rate of change of the indication of delay; and
when the counter exceeds a threshold value, modifying the connection to use the second IP path for transmission of packets between the first network node and the second network node.

2. The method according to claim 1, wherein the indication includes a Round Trip Time of the first IP path.

3. The method according to claim 1, wherein the setting of the counter comprises:
incrementing the counter when the second derivative indicates increasing rate of change of delay; and
decrementing the counter when the second derivative indicates decreasing rate of change of delay.

4. The method according to claim 1, wherein the determining of the indication of delay and the estimating of the second derivative of the indication of delay is performed at a time interval, which is dependent on the counter.

5. The method according to claim 1, wherein a set of IP paths includes the second IP path, wherein the method further comprises:
determining a set of respective indications of respective delays for one or more packets travelling in each of the IP paths of the set of IP paths, wherein each of the respective indications relates to time for each of said one or more packets to travel between the first network node and the second network node; and
estimating a respective variance for each respective indication of respective delays.

6. The method according to claim 5, wherein a set of variances includes each respective variance, wherein the set of respective indications includes a respective indication for each IP path of the set of IP paths, and wherein the modifying of the connection comprises:
selecting the second IP path out of the set of IP paths, wherein the respective variance for the respective indication of the second IP path is among the least of the set of respective variances, or wherein the respective variance for the respective indication of the second IP path is the least of the set of respective variances.

7. The method according to claim 5, wherein the indication includes a value indicating time spent in the second network node.

8. A first network node configured to manage a first Internet Protocol (IP) path used by a connection between the first network node and a second network node, wherein the connection is established in a transport layer of the first and second network nodes, wherein the transport layer is supported by an IP layer of the first and second network nodes, wherein the first network node manages a second IP path for use by the connection, and wherein the first network node is configured to:
determine an indication of delay for a packet travelling in the first IP path, wherein the indication relates to time for the packet to travel between the first network node and the second network node;
estimate a second derivative of the indication of delay, wherein the second derivative of the indication of delay indicates a rate of change of the indication of delay;
set, based on the second derivative of the indication of delay, a counter for tracking the rate of change of the indication of delay; and
when the counter exceeds a threshold value, modify the connection to use the second IP path for transmission of packets between the first network node and the second network node.

9. The first network node according to claim 8, wherein the indication includes a Round Trip Time of the first IP path.

10. The first network node according to claim 8, wherein the first network node is configured to set the counter by further being configured to:
increment the counter when the second derivative indicates increasing rate of change of delay; and
decrement the counter when the second derivative indicates decreasing rate of change of delay.

11. The first network node according to claim 8, wherein the first network node is configured to determine the indication of delay and estimate the second derivative of the indication of delay at a time interval, which is dependent on the counter.

12. The first network node according to claim 8, wherein a set of IP paths includes the second IP path, wherein the first network node further is configured to:
determine a set of respective indications of respective delays for one or more packets travelling in each of the IP paths of the set of IP paths, wherein each of the respective delays includes time for each of said one or more packets to travel between the first network node and the second network node; and
estimate a respective variance for each respective indication of respective delays.

13. The first network node according to claim 12, wherein a set of variances includes each respective variance, wherein the set of respective indications includes a respective indication for each IP path of the set of IP paths, and wherein the first network node is configured to modify the connection by being configured to:
select the second IP path out of the set of IP paths, wherein the respective variance for the respective indication of the second IP path is among the least of the set of respective variances, or wherein the respective variance for the respective indication of the second IP path is the least of the set of respective variances.

14. The first network node according to claim 8, wherein the indication includes a value indicating time spent in the second network node.

15. A non-transitory computer readable medium comprising computer readable code for managing a first Internet Protocol (IP) Path used by a connection between a first network node and a second network node, which when executed by a processor on the first network node causes the first network node to perform the method according to claim 1.

16. (canceled)
